(19) United States
(12) Patent Application Publication
(10) Pub. No.: US 2020/0007410 A1
(43) Pub. Date: Jan. 2, 2020

(54) VEHICLE COMMUNICATION SERVICE PERFORMANCE MONITORING

(71) Applicant: ViaSat, Inc., Carlsbad, CA (US)

(72) Inventor: Richard G WALSH, Bonsall, CA (US)

(21) Appl. No.: 16/020,105

(22) Filed: Jun. 27, 2018

(51) Int. Cl. H04L 12/24; H04L 29/08; H04L 12/26

(52) U.S. Cl. CPC H04L 41/22; H04L 43/045; H04L 67/12

(57) ABSTRACT

An apparatus for monitoring a network communication service comprises a network interface and control circuitry configured to establish a first network connection with a first remote server of a first vehicle using the network interface, receive a first set of network performance data from the first remote server via the first network connection, the first set of network performance data indicating a plurality of service performance metrics associated with a network communication service provided on the first vehicle, and generate first graphical interface data representing a first status icon associated with the first vehicle and a first service performance metric of the plurality of service performance metrics. A visual feature of the first status icon is based on the first set of network performance data and indicates a status level of the first service performance metric.

### BACKGROUND

The present disclosure relates generally to mobile communications systems, and more particularly to monitoring communication systems onboard vehicles.

As high-performance networking capabilities have been made available to mobile platforms, managing network performance and user satisfaction for these networks has increased in complexity. Therefore, improved methods of characterizing the performance of network communication services to mobile platforms are needed.

### SUMMARY

In some implementations, the present disclosure relates to an apparatus for monitoring a network communication service, the apparatus comprising a network interface and control circuitry configured to establish a first network connection with a first remote server of a first vehicle using the network interface, receive a first set of network performance data from the first remote server via the first network connection, the first set of network performance data indicating a plurality of service performance metric values associated with the network communication service, and generate first graphical interface data representing a first status icon associated with the first vehicle and a first service performance metric value of the plurality of service performance metric values, wherein a visual feature of the first status icon is based on the first set of network performance data and indicates a status level of the first service performance metric value.

In some embodiments, each of the service performance metric values corresponds to a service performance metric type of a plurality of service performance metric types that comprises one or more of data rate, quality of experience, network availability, content viewing startup time, and content rebuffering frequency. The first status icon may be associated with a trip of the first vehicle. In some embodiments, the status level of the first service performance metric value is one of a finite set of status levels. For example, the set of status levels may comprise one or more of a normal status level, an impaired status level, an error status level, an unknown status level, and an inapplicable status level. In some embodiments, the normal status level is associated with an icon having one or more of a green color and a checkmark symbol, the impaired status level is associated with an icon having one or more of a yellow color and an exclamation point symbol, the error status level is associated with an icon having one or more of a red color and an exclamation point symbol, and the unknown status level is associated with an icon having an exclamation point symbol feature. The visual feature may comprise at least one of a color and a shape.

In certain embodiments, the control circuitry is further configured to receive an indication of a first user input associated with the first status icon and, in response to the first user input, generate second graphical interface data representing a status value of the first service performance metric value.

In some embodiments, the status level of the first service performance metric value is based on a comparison of the first service performance metric value to a first threshold value. The status level of the first service performance metric value may be further based on a comparison of the first service performance metric value to a second threshold value that is less than the first threshold value. In some embodiments, the comparison is performed at least in part by the control circuitry.

In certain embodiments, the control circuitry is further configured to establish a second network connection with a second remote server of a second vehicle using the network interface, receive a second set of network performance data from the second remote server via the second network connection, and generate second graphical interface data representing a second status icon associated with the second vehicle and a second performance metric value indicated by the second set of network performance data.

In some embodiments, the control circuitry is further configured to establish a second network connection with a second remote server of a second vehicle using the network interface receive a second set of network performance data from the second remote server via the second network connection generate aggregated performance data based on the first set of network performance data and the second set of network performance data, and generate second graphical interface data representing a second status icon associated with the first vehicle, the second vehicle, and a second performance metric value indicated by the aggregated performance data.

In some implementations, the present disclosure relates to a method of monitoring a network communication service, the method comprising establishing a first network connection with a first server of a first vehicle, receiving a first set of network performance data from the first server via the first network connection, the first set of network performance data indicating a plurality of service performance metric values associated with the network communication service, and generating first graphical interface data representing a first status icon associated with the first vehicle and a first service performance metric value of the plurality of service performance metric values. The visual feature of the first status icon may be based on the first set of network performance data and indicates a status level of the first service performance metric value.

In some embodiments, each of the service performance metric values may correspond to one of a plurality of service performance metric types comprising one or more of data rate, quality of experience, network availability, content viewing startup time, and content rebuffering frequency. The status level of the first service performance metric value may be one of a finite set of status levels. For example, the set of status levels comprises one or more of a normal status level, an impaired status level, an error status level, an unknown status level, and an inapplicable status level. In some embodiments, the normal status level is associated with an icon having one or more of a green color and a checkmark symbol, the impaired status level is associated with an icon having one or more of a yellow color and an exclamation point symbol, the error status level is associated with an icon having one or more of a red color and an exclamation point symbol, the unknown status level is associated with an icon having an exclamation point symbol feature.

In some embodiments, the method further comprises receiving an indication of a first user input associated with the first status icon and, in response to the first user input, generating second graphical interface data representing a status value of the first service performance metric value. The status level of the first service performance metric value may be based on a comparison of the first service performance metric value to a first threshold value. In some embodiments, the status level of the first service performance metric value is further based on a comparison of the first service performance metric value to a second threshold value that is less than the first threshold value.

In certain embodiments, the method further comprises establishing a second network connection with a second server of a second vehicle, receiving a second set of network performance data from the second server via the second network connection, and generating second graphical interface data representing a second status icon associated with the second vehicle and a second performance metric value indicated by the second set of network performance data.

In some implementations, the present disclosure relates to a system for monitoring a network communication service, the system comprising a first vehicle server onboard a first vehicle and a communication service monitoring subsystem comprising a display device and an on-ground server configured to establish a first network connection with the first vehicle server using a network interface, receive a first set of network performance data from the first vehicle server via the first network connection, the first set of network performance data indicating a plurality of service performance metric values associated with the network communication service, and generate first graphical interface data representing a first status icon associated with the first vehicle and a first service performance metric value of the plurality of service performance metric values. A visual feature of the first status icon may be based on the first set of network performance data and may indicate a status level of the first service performance metric value.

In some embodiments, the display device is remotely located from the on-ground server. In certain embodiments, the system further comprises a second vehicle server onboard a second vehicle, wherein the on-ground server is further configured to establish a second network connection with the second vehicle server using the network interface, receive a second set of network performance data from the second vehicle server via the second network connection, and generate second graphical interface data representing a second status icon associated with the second vehicle and a second performance metric value indicated by the second set of network performance data.

### BRIEF DESCRIPTION OF THE DRAWINGS

Various embodiments are depicted in the accompanying drawings for illustrative purposes, and should in no way be interpreted as limiting the scope of this disclosure. In addition, various features of different disclosed embodiments can be combined to form additional embodiments, which are part of this disclosure.

FIG. 1 is a diagram of a network communications system in accordance with one or more embodiments.

FIG. 2 is a block diagram illustrating an on-ground server in accordance with one or more embodiments.

FIG. 3 is a diagram illustrating a vehicle interior in accordance with one or more embodiments.

FIG. 4 illustrates a graphical interface representing communication service status data associated with a plurality of vehicles in accordance with one or more embodiments.

FIG. 5 illustrates a graphical interface representing a set of vehicle data in accordance with one or more embodiments.

FIGS. 6A-6G illustrate example timeline graphical interfaces, which may represent one or more of a variety of types of trip data in accordance with one or more embodiments.

FIG. 7 illustrates a process for monitoring a network communication service in accordance with one or more embodiments.

### DETAILED DESCRIPTION

The headings provided herein are for convenience only and do not necessarily affect the scope or meaning of the claimed invention. In certain implementations, the present disclosure relates to systems, devices and methods for monitoring network communication systems and services onboard vehicles.

### Overview

Aircrafts and other vehicles may be equipped with onboard systems configured to provide communication services, such as wireless network services, to clients onboard the vehicle. The user experience with respect to consumption of media or other content using such communication services on a trip of the vehicle can be affected by the performance of the communication service, which may be related to, or based on, various service performance metric values. The term “trip,” as used herein, may refer to a travel segment and/or a period of time or space of travel between a beginning and ending of a travel segment of a vehicle and may include any flight, voyage, cruise, or excursion taken by or otherwise associated with a vehicle, such as an aircraft. Embodiments disclosed herein relate to the obtaining, determining, aggregating, and/or processing of network performance data relating to various service performance metric values. The network performance data may be compared to target and/or threshold values to determine status level(s), which may be represented by various icons indicating the status level(s).

In some implementations, embodiments of the present disclosure provide for the generation, provision, and/or presentation of graphical interface data representing certain per-vehicle trip data and/or vehicle data, as well as one or more icons or links associated therewith. The terms “graphical interface data” and “interface data,” as used herein, may refer to any data in a computer system that is related to the representation of one or more graphical user interfaces or portions thereof, and may include data and/or code providing instructions for generation and/or display/presentation of various graphical icons and other visual identifiers and/or features in a display device. That is, graphical interface data may represent various graphical icons and/or other visual identifiers or feature. Furthermore, graphical interface data may refer to any type of user interface pages or portions of pages having any type of content. For example, graphical interface data may refer to a page of a website, a page of a network-enabled application, or the like, or to any type of code used by a user interface to generate some or all of a webpage, content page, or interface. Graphical interface data may comprise code conforming to any suitable or desirable language, such as hypertext markup language (HTML) code, Java or Javascript code, Android code, iOS code, other embedded device operating system code, or the like. In some embodiments, interface data is generated, provided, and/or presented representing a table comprising per-vehicle status icons for a plurality of service performance metrics relating to communication service provided on one or more vehicles, as well as one or more vehicle identifiers, and/or trip identifiers, wherein the table is configured to serve as a menu for selection by a user to allow access to various vehicle data and/or trip data. In some embodiments, per-vehicle status icons may each correspond to a single vehicle of a plurality of vehicles and may be indicative of only service performance metric values of a communication service provided on the corresponding single vehicle.

As referenced above, communication service performance provided on aircrafts or other vehicles may be represented in a table by status icons associated with particular service performance metrics on a per-vehicle basis. User input, such as a click, tap, hover, or the like, associated with a per-vehicle status icon or a vehicle identifier or trip identifier icon or link may trigger, or result in, the generation, provision, and/or presentation of graphical interface data providing data related to a communication service provided on the vehicle with respect to one or more trips of the vehicle, or other data related to the vehicle or one or more trips thereof. Certain visual features of a status icon may indicate the status of a communication service provided on the vehicle, and therefore a user may be prompted to execute user input associated with an icon, or may otherwise be notified of communication service status, based on the visual feature(s) of the status icon. By allowing for user input and interaction associated with various links and/or icons in the table, a user may be able to quickly link to vehicle data and/or trip data for vehicles experiencing performance issues.

In some embodiments, each status icon may correspond to a single vehicle of a plurality of vehicles and/or a single performance metric value of the communication service provided on the single vehicle. A table or other interface may represent status icons for the plurality of vehicles, with each status icon representing a performance metric value for one of the plurality of vehicles on a per-vehicle basis. In this way, the interface provides specific and detailed performance data for each individual vehicle and provides for more accurate diagnosing of potential performance issues of an individual vehicle.

Performance metric values associated with a communication service provided on a vehicle and/or during a trip may correspond to one or more performance metric types. Each performance metric type may relate to various communication-service-related information. For example, among other possibilities, a performance metric type may be data rate measured service performance metric values corresponding to the data rate metric type may indicate a data rate and/or average data rate of a communication service of a vehicle during a trip. Various computations may be performed on the performance metric values, for example to determine a percentage of a trip that a performance metric value exceeded a target and/or threshold value. Such information may provide insight as to whether communication system equipment associated with the vehicle may be experiencing issues. Vehicle passenger experience reporting events and other vehicle and/or trip data may further be accessed and presented in connection with interface data generated in accordance with embodiments of the present disclosure. In some embodiments, visual feature(s) of performance metric icons provide an indication of an aggregation of multiple service performance metric values. For example, visual features of an aggregated status icon may indicate whether an overall health of a communication service system of the vehicle is good, fair, poor, or other categorization.

### Communications System

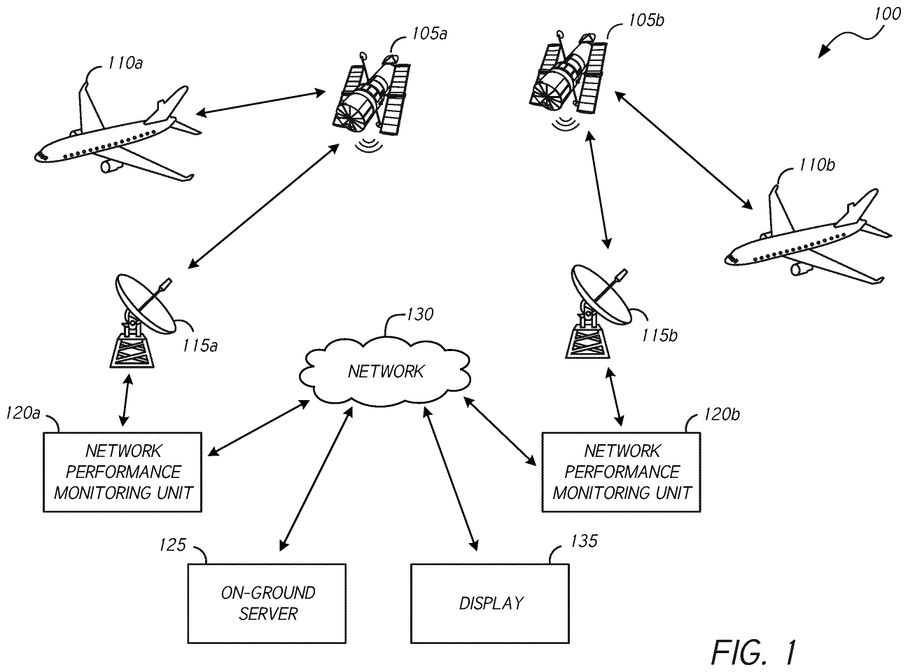

In some implementations, the present disclosure provides systems, methods, and devices that provide for monitoring of communication services and systems onboard a vehicle. FIG. 1 illustrates a communications system 100, which provides a context for various embodiments disclosed herein. Many other configurations are possible having more or fewer components than the communications system 100 of FIG. 1.

In the illustrated embodiment, the communications system 100 includes a plurality of vehicles 110a-b, shown as airplanes in FIG. 1 for convenience, which are in communication with a terrestrial network 130 via one or more satellites 105a-b and one or more network gateways 115a-b. Although FIG. 1 illustrates airplanes, it should be understood that the each of the vehicles 110a-b may be any type of vehicle, as described in greater detail below. Each of the vehicles 110a-b may include a two-way communication system to facilitate bidirectional communication with one of the one or more satellites 105a-b (or other type of access network, such as an air-to-ground network). In some embodiments, each of the vehicles 110a-b may be associated with one or more network service areas based on a present location of the vehicles 110a-b. For example, in some embodiments, if a vehicle 110a-b is within a geographic area associated with a first network service area of the one or more network service areas, then the vehicle 110a-b may be associated with the first network service area. Alternatively, a vehicle 110a-b may be associated with one or more network service areas based on an origin or destination of the vehicle 110a-b, with respect to a trip of the vehicle.

The vehicles 110a-b may be in communication with an on-ground server 125 via the network 130. In some embodiments, a respective network performance monitoring unit 120a-b may be positioned in a communication path between the vehicles 110a-b and the network 130, so as to monitor forward and/or return link performance of service provided to the vehicles 110a-b.

Each of the vehicles 110a-b may be any type of vehicle, such as an airplane, a train, a bus, a cruise ship, an automobile, etc. As illustrated, the network 130 can be any type of network and can include, for example, the Internet, an IP network, an intranet, a wide area network (WAN), local area network (LAN), a virtual private network (VPN), a virtual LAN (VLAN), a fiber optic network, a cable network, a public switched telephone network (PSTN), a public switched data network (PSDN), a public land mobile network, and/or any other type of network supporting communication as described herein. The network 130 can include both wired and wireless connections, as well as optical links.

While two vehicles 110a-b are shown in communication with the network 130 via two satellites 105a-b, techniques described herein can be applied in many other communications environments without departing from the scope of the inventions. Any or all such vehicle(s) 110a-b can communicate via any of one or more suitable communications architecture(s), including any suitable communications links or access networks, such as satellite communications systems, air-to-ground communication systems, hybrid satellite and air-to-ground communications systems, cellular communications systems, etc. Typically, because of the mobile nature of the vehicles 110a-b, the communications architecture will likely involve at least one wireless communications link.

The on-ground server 125 may include one or more electronic hardware computers or components, including control circuitry configured to perform certain functionalities, as discussed in greater detail below. The vehicles 110a-b may be configured to transmit vehicle-specific communication service performance data indicating one or more characteristics of communication service performance (e.g., network communication service) experienced onboard the vehicle while the associated onboard server is serviced by a particular network service area. The vehicle-specific communication service performance data may be transmitted or transferred from the vehicles 110a-b to the one or more satellites 105a-b, and further to one of the one or more gateways 115a-b, to the network 130, and to the on-ground server 125.

In some embodiments, the vehicles 110a-b may include position determination device(s), such as an inertial measurement unit (IMU) or global positioning system (GPS). Such devices, if installed, may allow the vehicle to determine its physical location, wherein such location information may be utilized by the on-ground server 125 in performing certain functionality disclosed herein. Alternatively, other techniques for determining a vehicle's location may be used. For example, in embodiments in which the satellite 105a-b is a spot beam satellite, a vehicle 110a-b may be able to derive its location based on the spot beam being used to communicate with the satellite network 160. In some embodiments, the vehicle 110a-b may transmit its position information to the on-ground server 125. The position information may be associated with vehicle-specific (e.g., per-vehicle) metric values that are collected near or at the reported position. This may allow the on-ground server 125 to correlate particular vehicle-specific metric values with specific network service areas based on the associated position. In some embodiments, location data for one or more of the vehicles 110a-b is obtained by the on-ground server 125 from a separate entity or server not shown in the diagram of FIG. 1, wherein such entity or server may receive location data from the vehicle(s) or otherwise derive the location data in some manner.

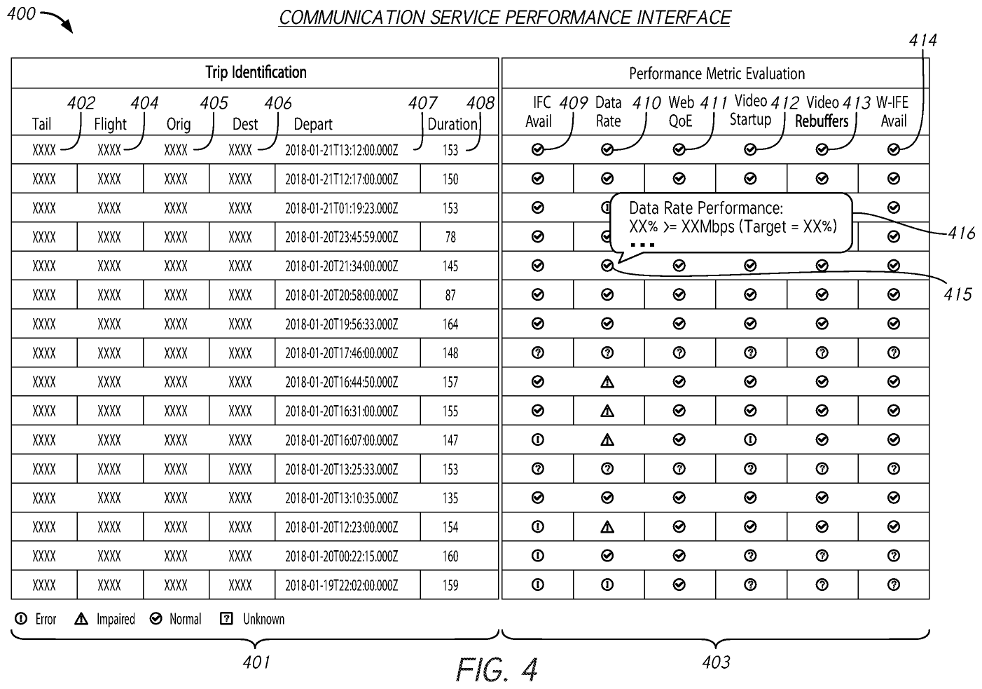

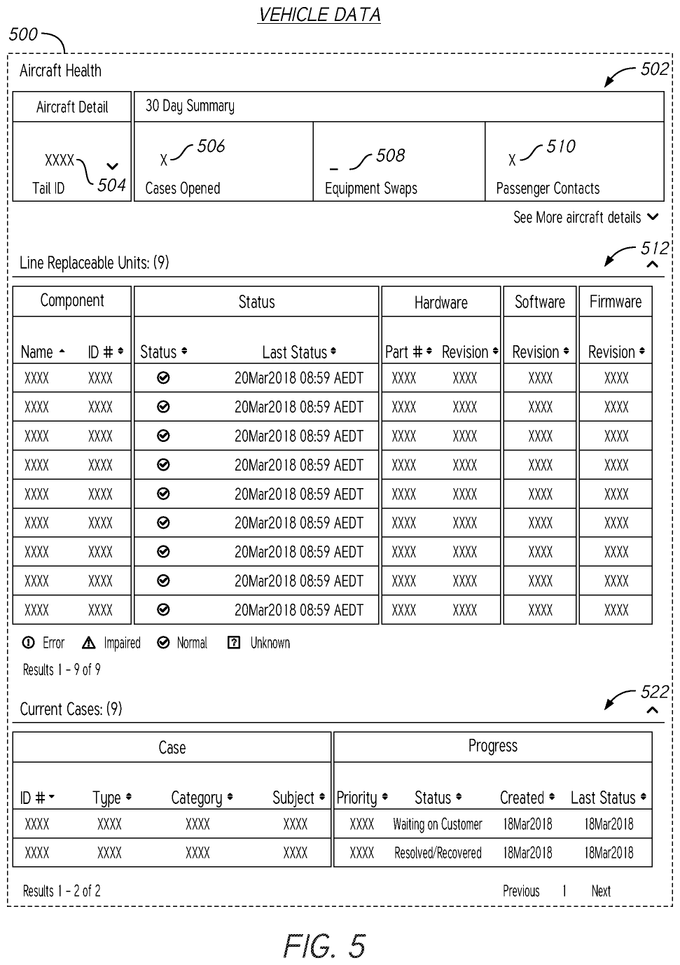

The on-ground server 125 may generate and/or provide graphical interface data for presentation on a display 135, for example at a monitoring station. In some embodiments, the display 135 may be a component of the on-ground server 125, while in other embodiments, the display 135 may connect to the on-ground server 125 via the network 130. The on-ground server 125 may provide user interface data for presentation on the display 135 similar to the example embodiments shown in FIGS. 4, 5A-B, 6A-G, and/or 7, discussed in detail below.

In some embodiments, one or more of the satellites 105a-b, gateways 115a-b, or other ground-based network equipment (not shown in FIG. 1) may be configured as the network performance monitoring units 120a-b, and thus may generate return link and/or forward link vehicle-specific performance data. For example, in some embodiments, the network performance monitoring units 120a-b may be routers or other types of network equipment, and may be positioned at one end of a communication link providing network communication to a vehicle 110a-b. A router may be configured to determine vehicle-specific communication service performance data by filtering data transmitted over the communication link to include only data destined for or received from a particular vehicle. The router may determine return link and/or forward link vehicle-specific communication service performance data, such as return link and/or forward link latency, throughput, dropped packet count or percentage, retransmission count or percentage, jitter, or other indicators of vehicle-specific return link and/or forward link communication service performance. In these aspects, the satellites 105a-b, gateways 115a-b, or other ground-based network equipment may be configured to send the vehicle-specific performance data to the on-ground server 125.

### On-Ground Server

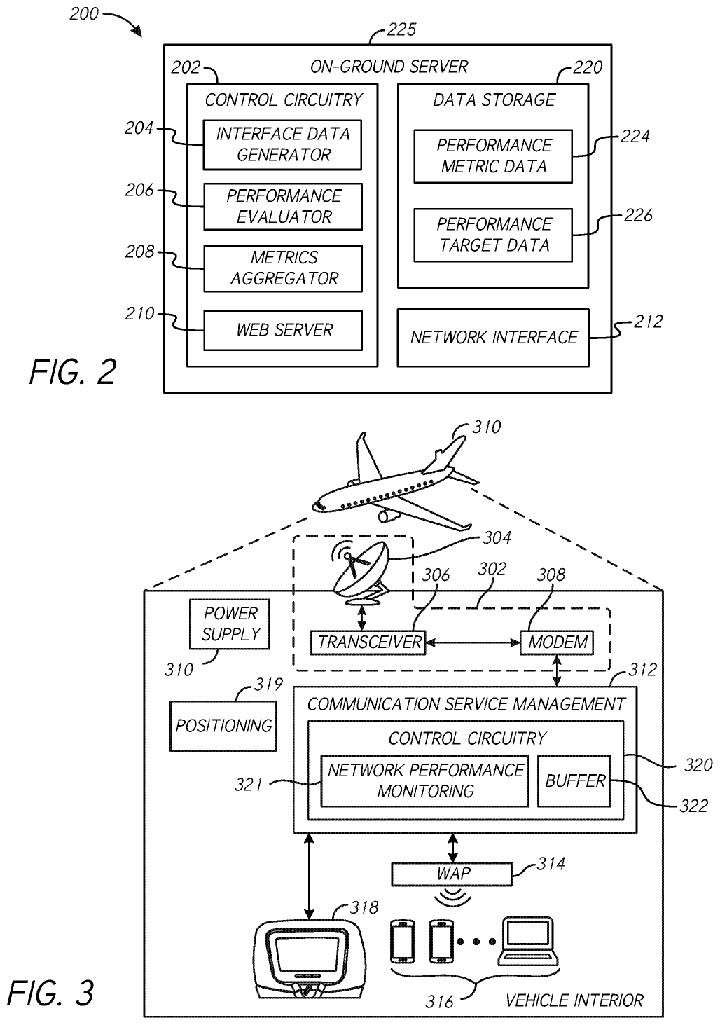

FIG. 2 is a block diagram illustrating an on-ground server 225 in accordance with one or more embodiments. The on-ground server 225 represents an example embodiment of the on-ground server 125 shown in FIG. 1 and described above. Many other configurations of the on-ground server 225 are possible having more or fewer components than those illustrated in FIG. 2. In some embodiments, the on-ground server 225 may be comprised of multiple physical computers, which may be geographically distributed across a wide area and connected via a network. In some embodiments, the on-ground server 225 comprises a single hardware computer contained within a single physical enclosure. In some embodiments, the on-ground server 225 is comprised of multiple physical enclosures, some of which are within a single physical enclosure and some of which are geographically distributed away from the single physical enclosure. Additionally, the functionalities described with respect to the on-ground server 225 can be distributed among the components of the system 100 of FIG. 1 in a different manner than shown or described herein.

With reference to FIG. 1, in some embodiments, communication service performance data for one or more vehicles 110a-b may be received by the on-ground server 125 via one or more satellites 105a-b. The illustrated components and features of the on-ground server 225, which represents an embodiment of the on-ground server 125 of FIG. 1, include control circuitry 202 and a network interface 212. The control circuitry 202 may be in communication with the network interface 212 via one or more electronic buses, or other connectivity features (not shown), of the on-ground server 225. The control circuitry 202 may communicate with the network interface 212 to transmit and/or receive packets over a network, such as a network providing connectivity to one or more vehicles, such as the vehicles 110a-b discussed above with respect to FIG. 1.

The control circuitry 202 may comprise one or more processors, volatile and/or non-volatile data storage devices, registers, amplifiers, filters, radio-frequency and/or baseband signal processing components, transceivers, device controllers, communication interfaces, and/or the like configured to perform certain functionality disclosed herein. The control circuitry 202 includes graphical interface data generator circuitry 204, performance evaluator circuitry 206, metrics aggregator circuitry 208, and web server circuitry 210. The functionality of each of the illustrated functional components of the control circuitry 202 can be embodied in code stored or maintained in one or more volatile or nonvolatile data storage devices, which may be part of a virtual or physical memory space accessible to the control circuitry 202. For example, the interface data generator 204, performance evaluator 206, metrics aggregator 208, and/or web server 210 may include code (e.g., binary data) defining instructions that configure the control circuitry 202 to perform their respective functions.

In some embodiments, the metrics aggregator 208 may include instructions that configure the control circuitry 202 to collect one or more performance metric values for a communication service provided on a monitored vehicle, such as an aircraft, and store the performance metric data 224 in the data storage 220. The metrics aggregator 208 may aggregate performance metric values for the communication service. For example, in some embodiments, the metrics aggregator 208 may generate an average, maximum, minimum, mean, and/or median of two or more communication service performance metric values for a communication service provided on a vehicle for at least one trip of the vehicle. The metrics aggregator 208 may determine negative variances between communication service performance metric values of a vehicle being monitored as it proceeds along its travel route. Such negative variances may themselves be aggregated to produce summary metric values (for example, one metric value) representing a difference in performance of a communication service of the monitored vehicle compared to certain performance targets 226, which may provide threshold values for evaluating communication service performance. In some embodiments, aggregation of negative variances may be divided by the duration of the given trip to the present point to provide an average negative variance experienced during the trip.

The performance evaluator 206 may compare aggregated communication service performance metric values to performance target data 226, which may include target threshold values for certain performance metric types. For example, performance target data 226 may be stored in the data storage 220, and may be accessed by the performance evaluator 206 or other component. The performance target data 226 may include values associated with Service Level Agreements (SLAs) and/or other target performance measures of the communication service, and may represent a variety of measurement types. In one embodiment, a performance target 226 may represent a target data rate, or a percentage of time the target data rate has been achieved. The metrics aggregator 208 may gather data rate statistics over a period of, for example, an entire trip of a vehicle. The performance evaluator 206 may collect the gathered data rate statistics and may compare them to data rate target values of the performance target data 226. Based on the comparison, the performance evaluator 206 may generate a data rate status level.

In some embodiments, communication service performance status levels associated with one or more communication service performance metric types and/or values may implement a multi-tiered threshold scheme, such as a two-tiered threshold scheme. For example, the performance target data 226 may include a first threshold indicating that a first data rate should be achieved for at least a first percentage of a given trip, and a second (e.g., lower) data rate should be achieved for at least a second (e.g., lower) percentage of the trip. If both the first data rate and second data rate targets are met, the performance evaluator 206 may indicate a positive (e.g., “normal”) data rate status level, whereas if either or both of the first data rate and the second data rate targets are not met, the performance evaluator 206 may indicate a negative (e.g., “impaired”) status level. The interface data generator 204 may receive communication service performance status and/or value data from the performance evaluator 206 and generate interface data including icons and/or values with corresponding visual features based on the determined status levels. For example, in some embodiments, in response to a positive status level indication, the interface data generator 204 may generate graphical interface data representing a green icon, and in response to a negative status indication, the interface data generator 204 may generate graphical interface data representing a yellow or red icon.

The web server 210 may include instructions that configure the control circuitry 202 to provide a web-based user interface. The web-based user interface may provide the ability for a user to provide user input for the configuring of one or more of the threshold values or other performance target data discussed herein. Additionally, the web-based user interface may provide graphical interface data representing metric values collected by the systems/components described herein. The web server 210 may further be configured to generate and/or provide graphical interface data generated by the interface generator 204 to one or more remote or local monitoring systems for display and/or presentation to a user. The web server 210 may receive indications of user input in connection with a graphical interface, wherein generation of graphical interface data by the interface data generator 204 may be triggered by such user input indications, as described in detail below.

With reference to FIGS. 1 and 2, in certain embodiments, the web server 210 may provide web page data to the one or more vehicles 110a-b, and the metrics aggregator 208 may collect metric values indicating quality of experience (e.g., how quickly the web pages load) at the one or more vehicles 110a-b. For example, the aggregated metric values may indicate a number of seconds required, at the one more vehicles 110a-b, to load the web page data provided by the web server 210. The performance evaluator 206 may compare the aggregated metric values to performance target data 226 (e.g., a target maximum number of seconds) and provide corresponding status data to the interface generator 204.

Web page and/or website content may be copied to, and/or served at, the web server 210. In this way, communication service performance metric values may be representative of performance of the communication network communicatively connecting the on-ground server 225 and the monitored vehicle, and may not be affected by performance issues that may affect transfer of content from the origin server (e.g., the server that created the website). The web server 210 may be a single server or may represent a distributed network of servers across a geographic area. The metrics aggregator 208 may collect metric values representative of a variety of content types, including flash pages, static content, and dynamically loaded content.

### Vehicle Onboard Communication Service System

FIG. 3 is a diagram illustrating a vehicle 310 in accordance with one or more embodiments. The vehicle 310 represents an example embodiment of one of the vehicles 110a-b shown in FIG. 1 and described above. The vehicle 310 may include various hardware devices, including one or more antennas 304, a transceiver 306, a modem 308, a power supply 310, communication service management system 312, one or more wireless access points (WAPs) 314, as well as one or more onboard media clients, which may comprise personal electronic devices (PEDs) 316 and/or passenger seat-back media systems 318. The antenna 304, transceiver 306, and modem 308 may comprise a two-way communication system 302 that may be configured to facilitate bidirectional communication with a satellite (e.g., one of satellites 105a-b in FIG. 1).

The two-way communication system 302 can provide for reception of a forward downlink signal from a satellite and transmission of a return uplink signal to the satellite to support two-way data communications between media clients within the vehicle 310 and a terrestrial network (e.g., the Internet). The PEDs 316 can include smartphones, laptops, tablets, netbooks, and the like brought onto the vehicle 310 by passengers or crew members. The PEDs 316 and/or seat back systems 318 can communicate with the communication service management system 312 via a communication link that can be wired and/or wireless. The communication link can be, for example, part of a local area network such as a WLAN supported by the one or more WAPs 314. WAPs 314 can be distributed about the vehicle 310, and can provide traffic switching and routing functionality; for example, as part of a WLAN extended service set (ESS), etc.

In operation, the communication service management system 312 installed within the vehicle 310 can provide uplink data received from the PEDs 316 and/or seatback systems 318 to the modem 308 to generate modulated uplink data (e.g., a transmit intermediate frequency (IF) signal) for delivery to the transceiver 306. The transceiver 306 can upconvert and then amplify the modulated uplink data to generate the return uplink signal for transmission to the satellite 105 via the antenna system 304. Similarly, the transceiver 306 can receive the forward downlink signal from a satellite via the antenna(s) 304. The transceiver 306 can amplify and down-convert the forward downlink signal to generate modulated downlink data (e.g., a receive IF signal) for demodulation by the modem 308. The demodulated downlink data from the modem 308 can be provided to the communication service management system 312 for routing to the PEDs 316. The modem 308 can be integrated with a network performance monitoring unit 321 of the communication service management system 312, or can be a separate component in some examples.

The network performance monitoring unit 321 may include, in some embodiments, one or more electronic hardware processors and/or electronic hardware memory devices, and one or more network interfaces. The electronic hardware processor may be configured to perform a variety of functions associated with monitoring the network performance of the communication service with respect to the vehicle 310.

The communication service management system 312 may include, in some embodiments, control circuitry 320 comprising the network performance monitoring unit 321 and a data buffer 322. The control circuitry 320 may be configured to perform a variety of functions associated with monitoring the network performance of the communications service provided on the vehicle 310 by the communication system 302 and the communication service management system 312.

In some embodiments, the communication service management system 312 may be configured to generate performance data associated with the communication service provided on the vehicle 310 by the communication system 302 and the communication service management system 312, and transmit the performance data over an access network. The performance data may be vehicle-specific performance data and/or trip-specific data. One or more metric values included in the performance data representing the measured performance of the communication service provided on the vehicle 310 may be generated by the communication service management systems 312.

In some embodiments, the performance data may indicate one or more metric values, the one or more metric values including one or more of a number or average number of dropped packets, average throughput or delays during a time period, an availability of the communication service during a time period, data rate, signal quality values, latency, packet loss rate, and a maximum number of PEDs 316 connected, with respect to the communication service. In some embodiments, the availability of network service may be represented as a percentage of time that network service was available to the communication service management system 312. In some embodiments, the vehicle-specific performance data may indicate an availability of one or more of uplink and/or downlink communications.

The communication service management system 312 (e.g., specifically, the network performance monitoring unit 321) may be further configured to periodically re-determine one or more of the metric values described above. For example, in some embodiments, a moving average of one or more of the metric values may be determined at a periodic interval. In some embodiments, the communication service management system 312 may be further configured to periodically report one or more of the metric values to an on-ground server (e.g., the on-ground server 125 and/or the on-ground server 225). In some embodiments, the communication service management system 312 may be configured to calculate forward link performance data, while another communication service management system installed off-board the vehicle 310 may be configured to calculate return link performance data.

The communication service management system 312 (e.g., specifically, the network performance monitoring unit 321) may also be configured to monitor a location of the vehicle 310 and to periodically report the location of the vehicle 310 over the access network to the on-ground server. For example, the vehicle 310 may comprise positioning circuitry, such as Global Positioning System (GPS) circuitry, configured to determine a present location or position of the vehicle 310. In some embodiments, the network performance monitoring unit 321 may associate one or more of the communication service performance metric values with one or more vehicle 310 locations, and report the association to the on-ground server.

The vehicle 310 comprises certain hardware devices used to provide the onboard communication service. At least some of the hardware devices used for communication service provision on the vehicle may be self-reporting, for example by providing periodic status updates to the communication service management unit 312. If a status update is not received from a hardware device after a given period of time, the status of the hardware device may be designated as “unknown,” or may be defaulted to “impaired.” Certain hardware devices may be configured to recognize when it is experiencing an issue, such as not receiving a requisite voltage level. In such cases, the hardware device may generate an “error” status. Status updates collected by the control circuitry 320 may be transmitted via the communication system 302 when requested by the on-ground server or based on other events.

### Communication Service Performance Interfaces

FIG. 4 illustrates a graphical interface 400 representing communication service performance icons associated with a plurality of vehicles and/or trips in accordance with one or more embodiments. The interface 400 includes a first area 401 and a second area 403. The first area 401 represents a plurality of vehicle identifiers 402 and associated flight identifiers 404. The first area 401 may further represent various trip-related information, including trip origin 405, trip destination 406, trip departure date/time 407, and trip duration 408 data. The vehicle identifiers 402 may be any identifying labels or values assigned to vehicles, such as a tail ID for aircraft embodiments. The trip identifiers 404 may be any identifying labels assigned to a trip of a vehicle, such as a flight number for aircraft embodiments. The duration 408 may be represented in a number of minutes, hours, and/or other measurement. Other trip-, or vehicle-related information may be included in some embodiments, including vehicle owner/operator information, vehicle type information, and/or trip crew information, among others. Each line or row of the first area 401 and second area 403 may be associated with a trip made by a particular vehicle.

In the illustrated interface 400, as well as other interfaces disclosed herein, the character ‘X’ is used to represent an arbitrary or generic character value, and may be representative of any number of characters or values. Furthermore, a string of multiple characters ‘XX . . . ’ may be representative of any string of one or more characters or values, such as alphanumeric characters.

Each of the vehicle identifier 402 and the trip identifier 404 may have associated hyperlinks. In some embodiments, as described in detail below, a hyperlink associated with the vehicle identifier 402 may be associated with a request to generate graphical interface data representing a vehicle health page. In some embodiments, as described in detail below, a hyperlink associated with the trip identifier 404 may be associated with a request to generate graphical interface data representing a trip data page. Therefore, the interface 400 may advantageously provide an efficient and simple view of performance metric values, as well as a navigational tool for accessing additional information relating to vehicles and/or trips. By accessing the interface 400, users may be able to quickly identify vehicles which may be experiencing issues. Moreover, the interface 400 may include various interactive features to allow users to quickly access additional information relating to communication system and/or hardware status of vehicles of interest with respect to one or more trips of the vehicle.

The second area 403 represents a plurality of status icons 409-414, each representing a determined status level of a particular performance metric value on a per-vehicle basis for a trip of a vehicle. In the example shown in FIG. 4, each icon represents one of communication service connectivity availability 409 (e.g., in-flight connectivity (IFC) availability in the case of an aircraft), data rate 410, web quality of experience (QoE) 411, content viewing (e.g., video) startup time 412, content (e.g., video) rebuffering frequency 413, and wireless data availability 414 (e.g., wireless in-flight entertainment (W-IFE) availability in the case of an aircraft). Although status icons are illustrated in FIG. 4 relating to certain performance metric types, it should be understood that the principles disclosed herein are applicable to graphical interfaces having status icons relating to performance metric types not shown in FIG. 4, and/or one or more of the performance metric types shown in FIG. 4 may not be included in some embodiments. Furthermore, although six types of performance metric status icons are shown, it should be understood that embodiments of the present disclosure may relate to graphical interfaces having any number of types of performance metric status icons.

Each performance metric type represented in the interface 400 is discussed in further detail below. In some embodiments, performance metric values may be represented in the second area 403 as statistical values on a per-vehicle basis. In other embodiments, including the example illustrated in FIG. 4, performance metric values may be represented as icons having any of a variety of visual features indicative of status levels associated with the respective icons. Such icons may be referred to herein as status icons, or per-vehicle status icons, indicating the status represented by the icon relates to a specific or particular vehicle (e.g., one vehicle of a fleet or plurality of vehicles) and/or communication service provided on the specific/particular vehicle. Each row of the interface 400 may generally correspond to a single vehicle and/or single flight of a particular vehicle, as identified by the vehicle 402 and/or trip 404 identifiers. Example visual features may include one or more colors, shapes, and symbols. In some embodiments, visual features of icons may represent a status of a given metric value for a particular vehicle. In one use case, a “normal” status may be represented by an icon having one or more of a circle shape, green color, and a checkmark symbol. In another use case, an “impaired” status may be represented by an icon having one or more of a triangle shape, yellow color, and an exclamation point symbol. In another use case, an “unknown” status may be represented by an icon having one or more of a circle shape, a gray color, and a question mark symbol. In another use case, an “error” status may be represented by an icon having one or more of a circle shape, a red color, and an exclamation point symbol.

Each of the icons 409-414 may be selectable via user input. In certain embodiments, a hover event (or a click, tap, or other user input event) at a first icon 415 may cause generation of a popup box 416 at or near the first icon 415. The popup box 416 may include communication service performance data of the performance metric type represented by the first icon 415. For example, the popup box 416 may provide summary data indicative of comparisons between the associated performance metric values and a target and/or threshold value for the performance metric type.

Each of the performance metric values may be compared to one or more target and/or threshold values. For example, one or more target and/or threshold values may be stored (e.g., in the performance target data 226 of the data storage 220 illustrated in FIG. 2) and may be compared to received statistics (e.g., from the communication service management unit 312 of FIG. 3). Comparisons may be based on single measurements (e.g., a measured data rate value compared to a single target and/or threshold data rate value) or a collection of measurements (e.g., an average of data rate values compared to a target and/or threshold value). Moreover, multiple comparisons may be combined to represent a single comparison. For example, received data rate values may be compared to target data rate values over the course of a trip and a percentage value representing how often the received data values met or exceeded the target data rate values during the trip may be compared to a target percentage value.

In certain embodiments, a data rate icon 410 may be representative of outcomes of one or more comparisons between one or more measured data rate values and one or more target values. The term “data rate,” as used herein, may refer to a speed at which data is transferred within a computing device and/or between computing devices of a network. Data rate may be measured by a number of bytes (or, e.g., kilobytes) per second, and can be averaged across devices and/or across a period of time.

In some embodiments, a single performance metric value may be compared to multiple thresholds. For example, a received data rate value may be compared to both a first (e.g., relatively higher) target data rate value (e.g., representing “excellent” performance) and a second (e.g., relatively lower) target data rate value (e.g., representing “adequate” performance). In some embodiments, a single performance metric icon 409-414 may represent multiple comparisons. For example, the first icon 415 may represent a first comparison and a second comparison (and in some cases, additional comparisons). The first comparison may be a comparison of (1) a first percentage value representing how often received data rate values met or exceeded a first target data value during a trip to (2) a first target percentage value. The second comparison may be a comparison of (1) a second percentage value representing how often received data rate values met or exceeded a second target data value during a trip to (2) a second target percentage value. Each of the first comparison and the second comparison may result in a “pass” or “fail” outcome. Visual features of the first icon 415 may be determined based on the pass or fail outcomes for either or both of the first and second comparisons. In one use case, if both comparisons result in a pass outcome, the first icon 415 may have one or more of a green color, a circle shape, and a checkmark symbol (e.g., representing a “normal” status). In another use case, if either or both of the first and second comparisons result in a fail outcome, the first icon 415 may have one or more of a red color, circle shape, and an exclamation point symbol (e.g., representing an “error” status). Although two threshold comparisons are described in certain use cases above, it should be understood that status icon data may represent more than two threshold comparisons, or a single threshold comparison. Furthermore, although the above description of threshold comparisons is described in the context of data rate performance metric values, such description is applicable to comparisons of other performance metric types.

In certain embodiments, a connectivity availability icon 409 may be representative of outcomes of one or more comparisons between one or more measured communication service connectivity availability values and one or more target values. Connectivity availability may be indicative of how many signal responses were received in response to pings. The term “ping,” as used herein, may refer to any signal or communication transmitted at, or received from, a computing device over a network. In some embodiments, connectivity availability may be measured as a percentage measurement indicative of a percentage of times a response was received following a transmitted ping. In some embodiments, connectivity availability may be averaged over a period of time (e.g., an entire trip). For example, a ping may be transmitted every few seconds and the number of transmitted pings over a period of one or more minutes may be divided by the number of responses to the transmitted pings.

In certain embodiments, a QoE icon 411 may be representative of outcomes of one or more comparisons between one or more measured QoE values and one or more target values. The terms QoE and “quality of experience,” as used herein may refer to an evaluation of network performance as determined by download and/or upload speeds of the network. In some embodiments, QoE may be measured as an amount of time (e.g., a number of seconds) required for a web page or other interface data to load. Accordingly, measured QoE values and target QoE values may be represented as load times. In some embodiments, a web page or other interface data may be first copied to the communication system and served from an on-board server or on-ground server of the communication system for measurement purposes rather than from external origin web servers to avoid introducing issues associated with external web servers. In certain embodiments, a plurality of commonly accessed websites may be periodically uploaded to a vehicle to test loading times of the websites. Comparisons may be based on load times of one or more of the plurality of websites. For example, if any of the uploaded websites fails to load within a target amount of time during a first trip, a QoE icon 411 associated with the trip may represent a fail outcome.

In certain embodiments, a content viewing startup time icon 412 may be representative of outcomes of one or more comparisons between one or more measured content viewing startup time values and one or more target values. Content viewing startup values may be representative of an amount of time required for media content (e.g., a video) to start playing and/or be displayed following a command to play the media content. In some embodiments, media content may be played by an on-ground server (e.g., the on-ground server 125 of FIG. 1) and the media content may be transmitted from the on-ground server to a vehicle. Content viewing startup time measurements may indicate a difference between a first point at which an on-ground server initiates a command to play media content and a second point at which a server onboard a vehicle begins playing the media content.

In certain embodiments, a content rebuffering frequency icon 413 may be representative of outcomes of one or more comparisons between one or more measured content rebuffering values and one or more target values. Content rebuffering values may be representative of how many times media content (e.g., a video) buffers (i.e., stops playing for a period of time until required data is loaded) during a period of time. Content rebuffering frequency and other metric values may be compared to multiple target values. For example, a value of content rebuffering frequency during playback of media content may be compared to a first (e.g., relatively higher) target content rebuffering frequency value and to a second (e.g., relatively lower) target content rebuffering frequency value. In one use case, a content rebuffering frequency value may be a number of rebuffers per hour of media content. In some embodiments, if both of two target content rebuffering frequency values are met or exceeded, a corresponding content rebuffering frequency icon 413 may have a green color visual feature. If only one of two target content rebuffering frequency values are met or exceeded, a corresponding content rebuffering frequency icon 413 may have a yellow color visual feature. If both of two target content rebuffering frequency values are not met or exceeded, a corresponding content rebuffering frequency icon 413 may have a red color visual feature. In some embodiments, content rebuffering frequency and/or other performance metric values may be measured at an onboard server of a vehicle rather than at a user device.

Target values for content viewing startup time and content rebuffering frequency may be set to maximize user experience. For example, an option to avoid buffering can involve loading more content at the beginning of a media item, however by doing so it may increase content viewing startup time of the media item. Accordingly, target values for content viewing startup time may be increased (i.e., content viewing startup may take longer while still meeting target values) to an amount at which buffering would generally be at an acceptable level. In some embodiments, media content may be buffered at an onboard communication service management system and transmitted to user device. In some use cases, content viewing startup time and/or content rebuffering frequency target values may be adjusted based on specifications (e.g., length, definition, display rate) of a played media item.

In certain embodiments, a wireless data availability icon 414 may be representative of outcomes of one or more comparisons between one or more measured wireless data availability values and one or more target values. Wireless data availability may represent availability of wireless services at one or more points in time during a trip.

The communication service performance interface 400 advantageously provides an at-a-glance representation of communication service performance as related to communication service performance targets on a per-vehicle basis. In some embodiments, each status icon 409-414 may provide vehicle-specific communication service performance data for a single vehicle and/or a single performance metric value and/or type. Communication service performance targets may be based at least in part on service level agreement targets, which may be complex in nature and involve a variety of measured and/or target values for each performance metric type. Thus, a simple representation providing comparison results of a plurality of performance metric values to a plurality of target values may improve an ability to recognize and respond to potential issues.

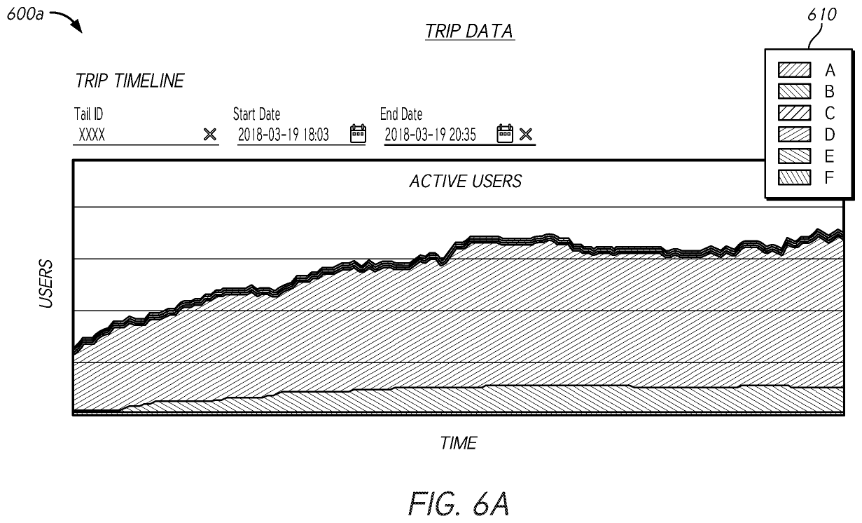

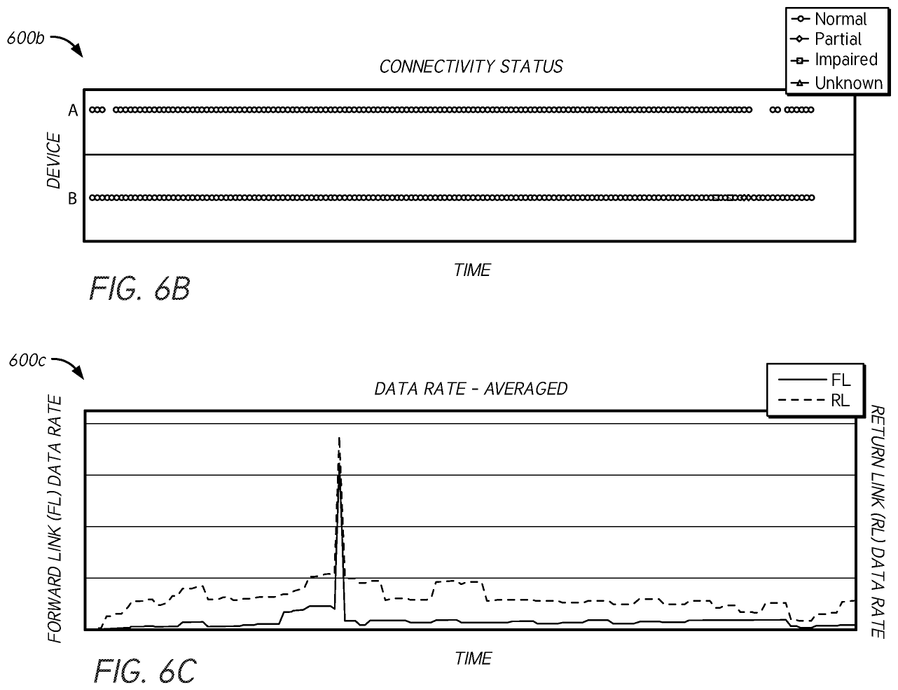

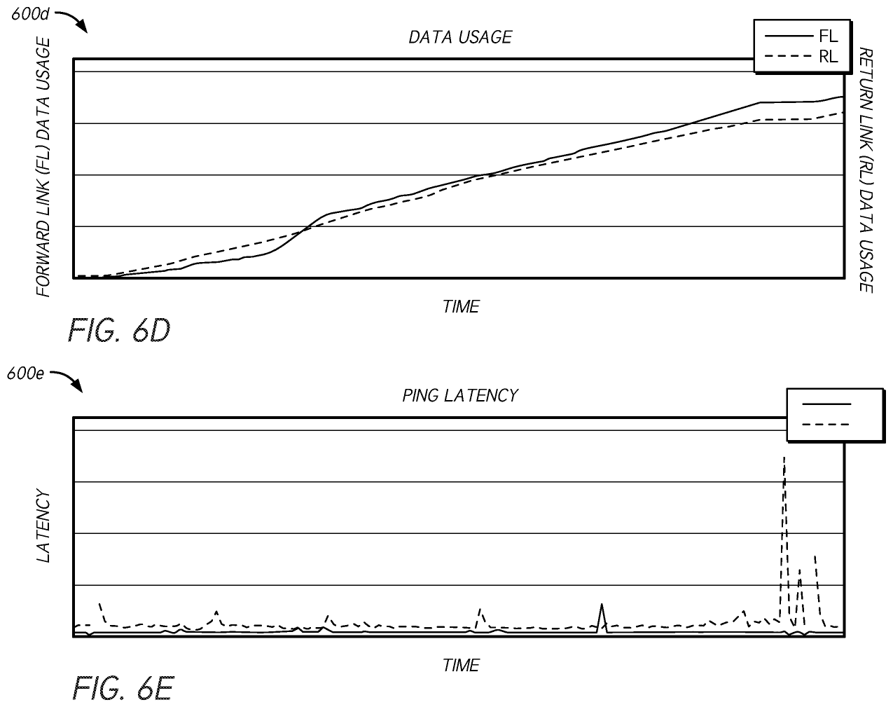

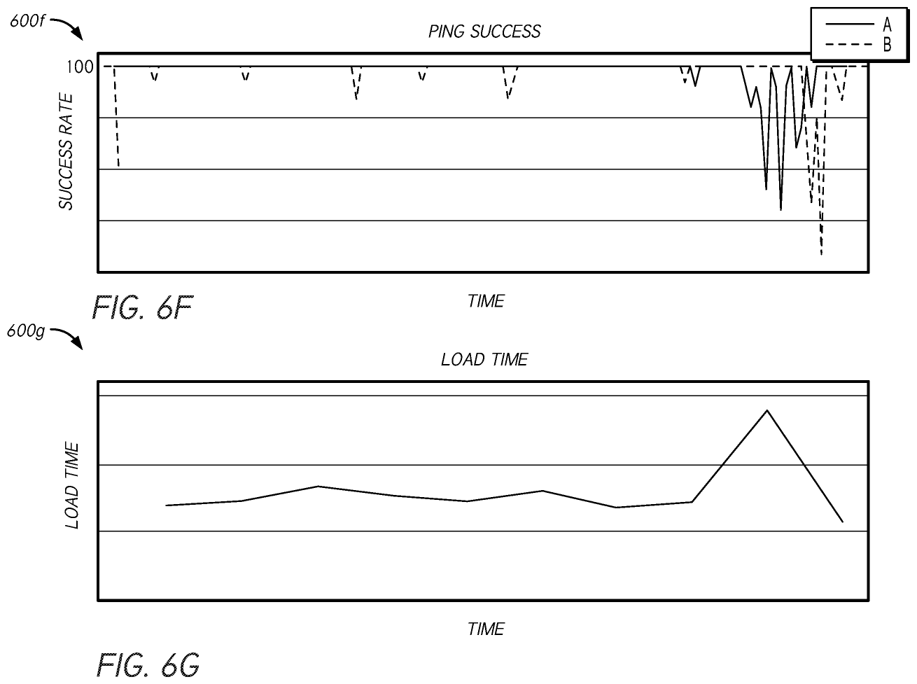

In certain embodiments, the communication service performance interface 400 includes icons having visual features that quickly indicate to users how performance metric values compare to target values on a per-vehicle basis. Users can interact with the interface 400 to access popup boxes or other interfaces which provide summary and/or simplified metric statistics (e.g., by hovering over an icon). Moreover, users can further interact with the interface 400 to trigger generation of additional interface data providing detailed performance metric statistic information (e.g., by clicking on an icon, a user may be routed to a detailed statistic interface). In this way, users can quickly visually scan multiple icons and/or access summary data to determine vehicles, flights, and/or communication service systems requiring attention, and access detailed results. In some embodiments, icons may reflect service performance over a particular period of time, for example an entire trip. In some cases, performance metric values may be measured and/or compared to target values after a trip is completed. As described above, the graphical interface 400 of FIG. 4 can include one or more of a vehicle identifier 402 and a trip identifier 404. User input associated with the vehicle identifier 402 may cause the generation, provision, and/or presentation of graphical user interface data representing certain vehicle data. Examples of vehicle data that may be provided in a vehicle data graphical interface are shown in FIG. 5 and described in detail in connection therewith, although other examples of vehicle data are possible within the scope of the present disclosure. User input associated with the trip identifier 404 may cause the generation, provision, and/or presentation of graphical user interface data representing certain trip data. Examples of trip data that may be provided in a trip data graphical interface are shown in FIGS. 6A-6G and described in detail in connection therewith.

In some embodiments, communication service performance icons, vehicle data, and/or trip data included in the communication service performance interface 400 may be sorted in response to user inputs. For example, clicking on a trip departure date/time column of the communication service performance interface 400 may cause trips represented in the communication service performance interface 400 to be sorted based on departure date/time. In some embodiments, the communication service performance interface 400 may be filtered to include only trips satisfying certain criteria provided by user input. For example, a user may request to view only trips having data rate icons 410 with an “error” status level. In some embodiments, filtering controls may be included in the communication service performance interface 400. For example, the communication service performance interface 400 may comprise one or more drop-down menus which allow users to select filtering criteria.

In certain embodiments, users may provide credentials or other identifying information in connection with accessing the communication service performance interface 400. For example, a user may be required to log into a registered account in order to view at least some of the communication service performance interface 400. In some embodiments, users may have associated user types and/or access privileges. For example, a user account may indicate a company or other entity that the user is associated with. In some embodiments, at least some communication service performance icons, vehicle data, and/or trip data may be restricted based on user identifying information. For example, only users having a user account indicating an association with a first entity may be authorized to view trip details for trips operated by the first entity. In another example, only users having a user account indicating a particular position with the first entity may be authorized to view data rate icons QoE icons 411 for trips operated by the first entity.

In some embodiments, at least some data included in a communication service performance interface 400 may be exported. For example, communication service performance interface 400 data may be exported to a comma-separated values (CSV) file for use in an external application. The communication service performance interface 400 may include an “export” icon which may be configured to generate an export file in response to a user input.

### Vehicle Data Graphical Interfaces

FIG. 5 illustrates a graphical interface 500 representing a set of vehicle data in accordance with one or more embodiments. In some embodiments, the graphical interface 500 and/or associated interface data may be generated in response to user input associated with a vehicle identifier, such as user input associated with the vehicle identifier 402 of the interface 400 shown in FIG. 4 and described above, or similar interface. The vehicle data interface 500 may include a vehicle health table 502, which may comprise the vehicle identifier 504, data related to open cases 506, data related to equipment swaps 508, and/or data related to passenger contacts 510.

Cases 506 may be any reports generated by passengers and/or personnel associated with a vehicle. A case 506 may represent a reported problem associated with the vehicle, for example. The number of cases 506 opened for the vehicle may be included in the health table 502, while a list of cases reported within a given period of time may be included in a cases table 522. Each listed case may have an identification number, a type, a category, and a subject. The case table 522 may further include progress information for each case, for example a priority level, a status, a date/time created, and a most recent status date/time.

The vehicle data interface 500 may further include a hardware device table 512, which may comprise a variety of data related to individual hardware devices of the vehicle. For example, the listed hardware devices may be associated with the communication service provided onboard the vehicle. Each device may be provided in connection with a data entry comprising one or more of the associated device name, identification number, status, hardware information (which may include a part number and/or revision number), software information (which may include a revision number), and firmware (which may include a revision number).

Information included in the vehicle data interface 500 may be useful in diagnosing issues with a vehicle. For example, a large number of cases opened for a vehicle may indicate a possible issue, and certain responsive measures may be taken. For example, equipment within the vehicle may be replaced based on vehicle data presented in the vehicle data interface 500. Using equipment status information on the vehicle device table 512 may indicate whether replacement of equipment has corrected a known issue. With reference back to the graphical interface 400 of FIG. 4 described above, if a performance metric icon on the graphical interface 400 indicates a possible issue with the associated vehicle (e.g. measured data rate values are below all threshold values), a user may select the vehicle identifier 402 to view the vehicle data interface 500 to better diagnose the issue.

### Trip Data Graphical Interfaces

Selecting a trip identifier (e.g., trip identifier 404 in FIG. 4) may cause generation of trip data graphical interface data representing a set of trip-specific communication service data for a selected trip. That is, for example, in response to receiving an indication of user input associated with a trip identifier, in some embodiments, an on-ground server or other system or entity may generate graphical interface data representing a set of trip data, as described in detail herein. FIGS. 6A-6G illustrate example graphical interface timelines, which may represent one or more of a variety of types of trip data. As shown in Figured 6A-6G, types of trip data may include a number of active users (FIG. 6A), connectivity status (FIG. 6B), data rate (FIG. 6C), data usage (FIG. 6D), ping latency (FIG. 6E), ping success (FIG. 6F), and/or load time (FIG. 6G). Each illustrated timeline interface may represent statistical values over a period of time of interest. The period of time of a timeline may represent a set duration of time (e.g., a duration of a trip), or may represent a customized time range. In some embodiments, the time range may be divided into multiple points in time, and each point in time may have an associated statistical value represented in the timeline. As shown in FIG. 6A, a user may provide user input to select a start date/time and/or an end date/time. An interface representing the timeline may be generated to include a vehicle identifier for the vehicle represented by the vehicle data. In some embodiments, users may input different vehicle identifiers at the trip interface 600a to view statistics for different vehicles.

FIG. 6A illustrates a trip timeline graphical interface 600a representing a number of user devices accessing any of one or more communication service services 610 at each point in time during the specified time range. In some embodiments, a “user device” may be any client device accessing a network service of the one or more services. For example, a user device may be a PED belonging to a passenger of a vehicle, a network communication server on-board the vehicle (e.g., a server for managing subscriptions to the communications service or a server collecting communications service statistics), or a media server (e.g., providing in-flight entertainment content, or the like, to users), among others. Each user device may be associated with one or more communication services. In certain embodiments, communication services may include multiple levels of service that personal user devices may connect to by accessing a web portal, selecting a service, and in some cases paying a fee. Services that personal user devices may connect to may include a default service, a beta or trial service, and/or a premium service, among others.

The trip timeline interface 600a may be useful for determining when a break in service may have occurred. For example, if a portion of time in the illustrated time range shows no, or relatively few, connected users, it may be determined that there was a service issue during that period of time. The timeline may be zoomable to allow for focusing on certain portions of time. By zooming in, individual data points in the timeline may be clearer for viewing.

FIG. 6B illustrates a connectivity status timeline graphical interface 600b for one or more devices. In the example shown in FIG. 6B, the connectivity status timeline shows two devices (‘A,’ ‘B’). However, more devices or a single device may be represented in other examples. For each device, the timeline may represent any pings received from the device. Each ping may have an associated level which may be determined based on a quality of the ping. Example levels may include normal, partial, impaired, and/or unknown, among others. Each ping may be represented in the timeline based on the associated level. For example, a normal ping may be represented by a circle shape, a partial ping may be represented by a diamond shape, an impaired ping may be represented by a square shape, and an unknown ping may be represented by a triangle shape. However, such shape assignments are provided as examples only, and different levels may be represented by any suitable or desirable shape. Furthermore, ping levels may be associated with any other visual features, for example colors or shapes other than those listed above.

FIG. 6C illustrates a data rate timeline graphical interface 600c. Data rate may be measured by multiple measuring devices, for example a server and/or a modem on-board a vehicle. Measurements may be collected and downloaded to an on-ground server when service is available. In some embodiments, data rate measurements may be compared to threshold and/or target values and various statuses (e.g., overall vehicle status) as described herein may be modified based on the comparisons.

The timeline interface 600c may represent one or both of a forward link (FL) data rate and a return link (RL) data rate over a specified period of time. A FL data rate may refer to a data rate for transmitting data from an on-ground server to a vehicle. In some embodiments, FL data may be transmitted from the on-ground server to a satellite, then from the satellite to a server on the vehicle, then from the on-board server to a user device on the vehicle. FL data may generally be relatively greater in amount than return link data. RL data may refer to data transmitted (e.g., a request for a video or other media) from an on-board device to an on-ground server. For example, from a user device to an on-board server, from the on-board server to a satellite, and from the satellite to the on-ground server.

FIG. 6D illustrates a data usage timeline graphical interface 600d, which may represent a total amount of data usage over a period of time. In some embodiments, data usage amounts may be aggregated or accumulated over the course of a flight or other period of time. As shown in FIG. 6D, data usage may be collected for both forward link (FL) data rate and return link (RL) data rate.

FIG. 6E illustrates a ping latency timeline graphical interface 600e. The term “ping latency,” as used herein, may refer to an amount of time required to receive a response following a transmitted ping. The interface 600e illustrates an example ping latency timeline for two devices (‘A,’ ‘B’). However, ping latency interfaces 600e in accordance with the present disclosure may represent data for any number or type of devices. In some embodiments, measured ping latency values may be compared to threshold and/or target values and various statuses (e.g., overall vehicle status) as described herein may be modified based on the comparisons.

FIG. 6F illustrates a ping success timeline graphical interface 600f. The ping success timeline interface 600f may provide a success rate at various points in time. Success rate may be represented by a percentage measurement indicative of a percentage of times a response was received following a transmitted ping. In some embodiments, ping success may be averaged over a period of time. For example, a ping may be transmitted every few seconds and the number of transmitted pings over a period of one or more minutes may be divided by the number of responses to the transmitted pings.

Ping success may be compared to a threshold value during a given period of time. For example, there may be a threshold value for ping success over an entire flight. Accordingly, a number of transmitted pings over the course of the flight may be divided by the number of responses to the transmitted pings to determine an overall ping success for the flight. The overall ping success may then be compared to a threshold ping success value to determine a pass or fail status for the flight. In some embodiments, various statuses (e.g., overall vehicle status) as described herein may be modified based on comparisons to the threshold value.

FIG. 6G illustrates a load time timeline graphical interface 600g, which provides a measurement of load times over a given time range. In some embodiments, load times may be determined at periodic intervals during the period of time. Multiple load time measurements may be made using common data sets to promote consistency between results. For example, multiple load time measurements may be based on load times for the same webpage data, or webpage data from multiple websites from a group of selected websites at different times. Load time measurements may include load times for a variety of data types, for example flash page content, static content, and dynamically loaded content.

### Communication Service Monitoring Processes

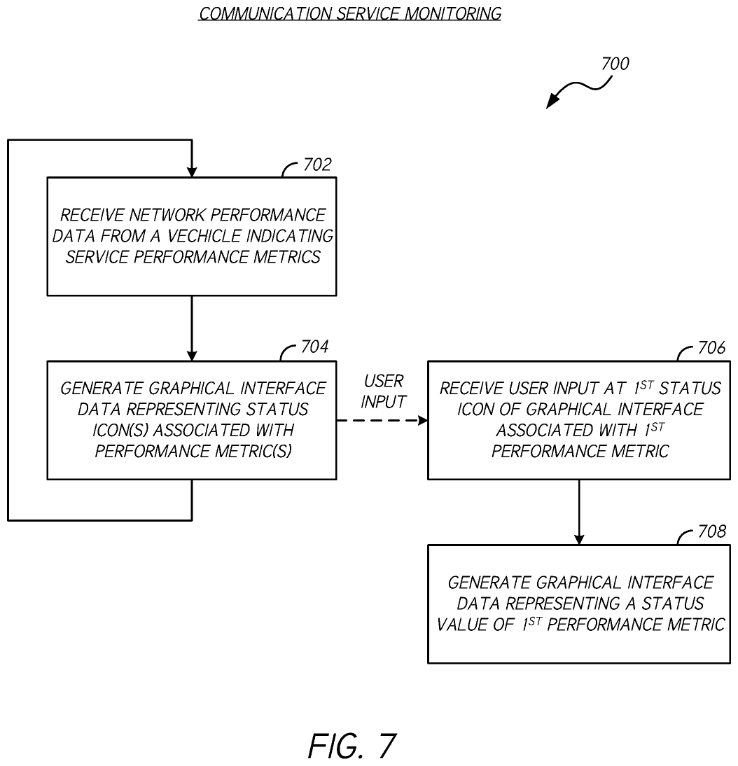

FIG. 7 illustrates a process 700 for monitoring a network communication service in accordance with one or more embodiments of the present disclosure. Steps of the process 700 may be performed by control circuitry of an apparatus for monitoring a network communication service onboard a vehicle. For example, the process 700 may be performed at least in part by an on-ground communication service monitoring server, such as the on-ground server 125 of FIG. 1 or the on-ground server 225 of FIG. 2, described in detail above. In certain embodiments, the apparatus performing some or all of the process 700 may be part of an on-ground server that is configured to monitor network communication services of multiples vehicles. With respect to the various methods and processes disclosed herein, although certain orders of operations or steps are illustrated and/or described, it should be understood that the various steps and operations shown and described may be performed in any suitable or desirable temporal order. Furthermore, any of the illustrated and/or described operations or steps may be omitted from any given method or process, and the illustrated/described methods and processes may include additional operations or steps not explicitly illustrated or described.

At block 702, the process 700 involves receiving network performance data from a vehicle. In some embodiments, the network performance data may be received through use of a network interface via an established network connection with remote onboard server of the vehicles. For example, the network performance data may be received (e.g., via the network interface 212 of FIG. 2) at an on-ground server (e.g., the on-ground server 225 of FIG. 2) from a communication system (e.g., the two-way communication system 302 of FIG. 3) onboard a first vehicle. The network performance data may indicate a plurality of service performance metric values associated with a communication service provided onboard the vehicle. For example, the plurality of service performance metric values may correspond to one or more service performance metric types, which may include data rate, QoE, network availability, content viewing startup time, and content rebuffering frequency. In some embodiments, the plurality of service performance metric values may be determined based on processing of the network performance data. For example, network performance data may provide statistical performance values for the communication service onboard the vehicle. The statistical performance values over a period of time (e.g., an entire trip) may be aggregated to generate an aggregated performance metric value that is indicative of a percentage of the period of time that the statistical performance values exceeded a given threshold value. As described herein with respect to FIG. 4, the aggregated performance metric value (e.g., a percentage value) may in turn be compared to a target and/or threshold performance metric value (e.g., a target percentage for the given value).

At block 704, the process 700 involves generating graphical interface data representing one or more status icons corresponding to the vehicle and one or more respective service performance metric values of the plurality of service performance metric values. In some embodiments, each status icon of the one or more status icons may indicate performance data for a single vehicle and may be represented in the graphical interface data on a per-vehicle basis. For example, the graphical interface data may represent a first status icon that is indicative of communication service performance for the vehicle with respect to a first service performance metric value of the plurality of service performance metric values. In some embodiments, the one or more status icons may be further associated with a particular trip of the vehicle. In some embodiments, the one or more status icons indicate status level(s) of the respective one or more service performance metric values. The status level(s) of the one or more service performance metric values may each be one of a finite set of status levels. For example, the set of status levels may comprise one or more of a “normal” status level, an “impaired” status level, an “error” status level, an “unknown” status level, and a “not applicable” status level.

In some embodiments, the various status levels may be represented by the one or more status icons using any of a variety of visual features. For example, visual features of a status icon may comprise at least one of a color and a shape. In one use case, the “normal” status level may be associated with an icon having one or more of a green color and a checkmark symbol. In another use case, the “impaired” status level may be associated with an icon having one or more of a yellow color and exclamation point symbol. In another use case, the “error” status level may be associated with an icon having one or more of a red color and an exclamation point symbol. In another use case, the “unknown” status level may be associated with an icon having an exclamation point symbol.

In some embodiments, a status level of a service performance metric value of the one or more service performance metric values may be based on a comparison of the service performance metric value to a first target or threshold value. For example, if the service performance metric value meets or exceeds the first target/threshold value, the status level may be “normal,” and if the service performance metric value does not meet or exceed the first target/threshold value, the status level may be “impaired,” or “error.” In some embodiments, the status level of the service performance metric value may be further based on a comparison of the service performance metric value to additional target/threshold values, such as a second target/threshold value that is less than the first threshold value. For example, if the first service performance metric value meets or exceeds a first target/threshold value but does not meet or exceed a second target/threshold value, the status level may be “impaired, or “error.” In some embodiments, the comparison of performance metric values to target/threshold values may be performed at least in part by control circuitry of an on-ground communication service monitoring server, such as the on-ground server 125 of FIG. 1 or the on-ground server 225 of FIG. 2.

In certain embodiments, one or both of blocks 702 and 704 may be iteratively performed for a plurality of vehicles, wherein the graphical interface data represents status icons associated with performance metric values for each of the plurality of vehicles. In some embodiments, the network performance data received at block 702 and/or the associated status icons of the graphical interface data may be updated periodically in response to newly received data. New location, vehicle, and/or trip data may be received on a periodic or other basis.

In some embodiments, network performance data for a plurality of vehicles may be received, and, in some embodiments, the network performance data for the plurality of vehicles may be aggregated. For example, where a first set of network performance data is received from a first vehicle, and a second set of network performance data is received from a second vehicle, aggregated performance data may be generated based on the first set of network performance data and the second set of network performance data. For example, the first set of network performance data and the second set of network performance data may be combined and/or averaged to form an aggregated data set for the first and second vehicles. In some embodiments, graphical interface data may be generated representing a status icon associated with a plurality of vehicles. For example, aggregated network performance data for a plurality of vehicles may be compared to target/threshold values and a status icon indicative of the comparison of the aggregated data to the target-threshold values may be generated. In some embodiments, aggregated performance data and/or the graphical interface data representing aggregated performance data may be generated based on user input. For example, in response to user input (e.g., at the interface 400), aggregated performance data and/or comparison results of aggregated performance data and target/threshold values for a plurality of vehicles (e.g., all vehicles associated with a first entity) may be represented in a single status icon. By representing aggregated performance data for a plurality of vehicles in a single status icon, users may be able to easily and efficiently evaluate performance for multiple vehicles of interest.

At block 706, the process 700 involves receiving an indication of user input associated with a first status icon of the one or more status icons. In some embodiments, the first user input may comprise a click, tap, hover, or similar event.

At block 708, the process 700 involves, in response to the user input, generating additional graphical interface data (e.g., the popup box 416 of FIG. 4) representing a status value of a first service performance metric value associated with the first status icon. The status value may indicate at least a portion of any of the network performance data, the first service performance metric value, a first target and/or threshold value, and/or additional target and/or threshold values.

### General Comments

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Description using the singular or plural number may also include the plural or singular number respectively. The word “or” in reference to a list of two or more items, that word covers all of the following interpretations of the word: any of the items in the list, all of the items in the list, and any combination of the items in the list.

Reference throughout this disclosure to “some embodiments,” “certain embodiments” or “an embodiment” means that a particular feature, structure or characteristic described in connection with the embodiment can be included in at least some embodiments. Thus, appearances of the phrases “in some embodiments,” “in certain embodiment,” or “in an embodiment” in various places throughout this specification are not necessarily all referring to the same embodiment, and may refer to one or more of the same or different embodiments. Furthermore, embodiments disclosed herein may or may not be embodiments of the invention. For example, embodiments disclosed herein may, in part or in whole, include non-inventive features and/or components. In addition, the particular features, structures or characteristics can be combined in any suitable manner, as would be apparent to one of ordinary skill in the art from this disclosure, in one or more embodiments.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While some embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

The various illustrative logical blocks, modules, data structures, and processes described herein may be implemented as electronic hardware, computer software, or combinations of both. To clearly illustrate this interchangeability of hardware and software, various illustrative components, blocks, modules, and states have been described above generally in terms of their functionality. However, while the various modules are illustrated separately, they may share some or all of the same underlying logic or code. Certain of the logical blocks, modules, and processes described herein may instead be implemented monolithically.

The various illustrative logical blocks, modules, data structures, and processes described herein may be implemented or performed by a machine, such as a computer, a processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor may be a microprocessor, a controller, a microcontroller, a state machine, combinations of the same, or the like. A processor may also be implemented as a combination of computing devices—for example, a combination of a DSP and a microprocessor, a plurality of microprocessors or processor cores, one or more graphics or stream processors, one or more microprocessors in conjunction with a DSP, or any other such configuration.

The blocks or states of the processes described herein may be embodied directly in hardware, in a software module executed by a processor, or in a combination of the two. For example, each of the processes described above may also be embodied in, and fully automated by, software modules executed by one or more machines such as computers or computer processors. A module may reside in a computer-readable storage medium such as RAM memory, flash memory, ROM memory, EPROM memory, EEPROM memory, registers, a hard disk, a removable disk, a CD-ROM, memory capable of storing firmware, or any other form of computer-readable storage medium. An exemplary computer-readable storage medium can be coupled to a processor such that the processor can read information from, and write information to, the computer readable storage medium. In the alternative, the computer-readable storage medium may be integral to the processor. The processor and the computer-readable storage medium may reside in an ASIC.

The accompanying claims and their equivalents are intended to cover such forms or modifications as would fall within the scope and spirit of the protection. For example, the various components illustrated in the figures may be implemented as software and/or firmware on a processor, ASIC/FPGA, or dedicated hardware. Also, the features and attributes of the specific embodiments disclosed above may be combined in different ways to form additional embodiments, all of which fall within the scope of the present disclosure. Although the present disclosure provides certain preferred embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

Methods and processes described herein may be embodied in, and partially or fully automated via, software code modules executed by one or more general and/or special purpose computers. The word “module” may refer to logic embodied in hardware and/or firmware, or to a collection of software instructions, possibly having entry and exit points, written in a programming language, such as, for example, C or C++. A software module may be compiled and linked into an executable program, installed in a dynamically linked library, or may be written in an interpreted programming language such as, for example, BASIC, Perl, or Python. It will be appreciated that software modules may be callable from other modules or from themselves, and/or may be invoked in response to detected events or interrupts. Software instructions may be embedded in firmware, such as an erasable programmable read-only memory (EPROM). “Module” may further refer to one or more devices, components, systems, or subsystems, which may conceptually implement relevant functionality. It will be further appreciated that hardware modules may be comprised of connected logic units, such as gates and flip-flops, and/or may be comprised of programmable units, such as programmable gate arrays, application specific integrated circuits, and/or processors. The modules described herein are preferably implemented as software modules, but may be represented in hardware and/or firmware. Moreover, although in some embodiments a module may be separately compiled, in other embodiments a module may represent a subset of instructions of a separately compiled program, and may not have an interface available to other logical program units.

What is claimed is:

1. An apparatus for monitoring a network communication service, the apparatus comprising:
a network interface; and
control circuitry configured to:
establish a first network connection with a first remote server of a first vehicle of a plurality of vehicles using the network interface;
receive a first set of network performance data from the first remote server via the first network connection, the first set of network performance data indicating a plurality of service performance metric values associated with a network communication service provided on the first vehicle, wherein each service performance metric value corresponds to a service performance metric type of a plurality of service performance metric types; and
generate first graphical interface data representing one or more per-vehicle status icons, wherein:
each of the one or more per-vehicle status icons corresponds to one vehicle of the plurality of vehicles and one or more service performance metric values; and
the one or more per-vehicle status icons comprises a first status icon corresponding to the first vehicle and a first service performance metric value of the plurality of service performance metric values;
wherein a visual feature of the first status icon is based on the first set of network performance data and indicates a status level of the first service performance metric value.

2. The apparatus of claim 1, wherein the plurality of service performance metric types comprises one or more of data rate, quality of experience, network availability, content viewing startup time, and content rebuffering frequency.

3. The apparatus of claim 1, wherein the first status icon is associated with a trip of the first vehicle.

4. The apparatus of claim 1, wherein the status level of the first service performance metric value is one of a finite set of status levels.

5. The apparatus of claim 4, wherein the set of status levels comprises one or more of a normal status level, an impaired status level, an error status level, an unknown status level, and an inapplicable status level.

6. The apparatus of claim 5, wherein the normal status level is associated with an icon having one or more of the following features:
a green color; and
a checkmark symbol.

7. The apparatus of claim 5, wherein the impaired status level is associated with an icon having one or more of the following features:
a yellow color; and
an exclamation point symbol.

8. The apparatus of claim 5, wherein the error status level is associated with an icon having one or more of the following features:
a red color; and
an exclamation point symbol.

9. The apparatus of claim 5, wherein the unknown status level is associated with an icon having an exclamation point symbol feature.

10. The apparatus of claim 5, wherein the visual feature comprises at least one of a color and a shape.

11. The apparatus of claim 1, wherein the control circuitry is further configured to:
receive an indication of a first user input associated with the first status icon; and
in response to the first user input, generate second graphical interface data representing a status value of the first service performance metric value.

12. The apparatus of claim 1, wherein the status level of the first service performance metric value is based on a comparison of the first service performance metric value to a first threshold value.

13. The apparatus of claim 12, wherein the status level of the first service performance metric value is further based on a comparison of the first service performance metric value to a second threshold value that is less than the first threshold value.

14. The apparatus of claim 12, wherein the comparison is performed at least in part by the control circuitry.

15. The apparatus of claim 1, wherein the control circuitry is further configured to:
establish a second network connection with a second remote server of a second vehicle using the network interface;
receive a second set of network performance data from the second remote server via the second network connection; and
generate second graphical interface data representing a second status icon associated with the second vehicle and a second performance metric value indicated by the second set of network performance data.

16. The apparatus of claim 1, wherein the control circuitry is further configured to:
establish a second network connection with a second remote server of a second vehicle using the network interface;
receive a second set of network performance data from the second remote server via the second network connection;
generate aggregated performance data based on the first set of network performance data and the second set of network performance data; and
generate second graphical interface data representing a second status icon associated with the first vehicle, the second vehicle, and a second performance metric value indicated by the aggregated performance data.

17. A method of monitoring a network communication service, the method comprising:
establishing a first network connection with a first server of a first vehicle of a plurality of vehicles;
receiving a first set of network performance data from the first server via the first network connection, the first set of network performance data indicating a plurality of service performance metric values associated with the network communication service provided on the first vehicle, wherein each service performance metric value corresponds to a service performance metric type of a plurality of service performance metric types; and
generating first graphical interface data representing one or more per-vehicle status icons, wherein:
each of the one or more per-vehicle status icons corresponds to one vehicle of the plurality of vehicles and one or more service performance metric values; and
the one or more per-vehicle status icons comprises a first status icon corresponding to the first vehicle and a first service performance metric value of the plurality of service performance metric values;
wherein a visual feature of the first status icon is based on the first set of network performance data and indicates a status level of the first service performance metric value.

18. The method of claim 17, wherein the plurality of service performance metric types comprises one or more of data rate, quality of experience, network availability, content viewing startup time, and content rebuffering frequency.

19. The method of claim 17, wherein the status level of the first service performance metric value is one of a finite set of status levels.

20. The method of claim 19, wherein the set of status levels comprises one or more of a normal status level, an impaired status level, an error status level, an unknown status level, and an inapplicable status level.

21. The method of claim 20, wherein the normal status level is associated with an icon having one or more of the following features:
a green color; and
a checkmark symbol.

22. The method of claim 20, wherein the impaired status level is associated with an icon having one or more of the following features:
a yellow color; and
an exclamation point symbol.

23. The method of claim 20, wherein the error status level is associated with an icon having one or more of the following features:
a red color; and
an exclamation point symbol.

24. The method of claim 20, wherein the unknown status level is associated with an icon having an exclamation point symbol feature.

25. The method of claim 17, further comprising:
receiving an indication of a first user input associated with the first status icon; and
in response to the first user input, generating second graphical interface data representing a status value of the first service performance metric value.

26. The method of claim 17, wherein the status level of the first service performance metric value is based on a comparison of the first service performance metric value to a first threshold value.

27. The method of claim 26, wherein the status level of the first service performance metric value is further based on a comparison of the first service performance metric value to a second threshold value that is less than the first threshold value.

28. The method of claim 17, further comprising:
establishing a second network connection with a second server of a second vehicle;
receiving a second set of network performance data from the second server via the second network connection; and
generating second graphical interface data representing a second status icon associated with the second vehicle and a second performance metric value indicated by the second set of network performance data.

29. A system for monitoring a network communication service, the system comprising:
a first vehicle server onboard a first vehicle of a plurality of vehicles; and
a communication service monitoring subsystem comprising:
a display device; and
an on-ground server configured to:
establish a first network connection with the first vehicle server using a network interface;
receive a first set of network performance data from the first vehicle server via the first network connection, the first set of network performance data indicating a plurality of service performance metric values associated with the network communication service, wherein each service performance metric value corresponds to a service performance metric type of a plurality of service performance metric types; and
generate first graphical interface data representing one or more per-vehicle status icons, wherein:
each of the one or more per-vehicle status icons corresponds to one vehicle of the plurality of vehicles and one or more service performance metric values; and
the one or more per-vehicle status icons comprises a first status icon corresponding to the first vehicle and a first service performance metric value of the plurality of service performance metric values;
wherein a visual feature of the first status icon is based on the first set of network performance data and indicates a status level of the first service performance metric value.

30. The system of claim 29, wherein the display device is remotely located from the on-ground server.

31. The system of claim 29, further comprising a second vehicle server onboard a second vehicle, wherein the on-ground server is further configured to:
establish a second network connection with the second vehicle server using the network interface;
receive a second set of network performance data from the second vehicle server via the second network connection; and
generate second graphical interface data representing a second status icon associated with the second vehicle and a second performance metric value indicated by the second set of network performance data.
